(19) United States
(12) Patent Application Publication
(10) Pub. No.: US 2009/0045761 A1
(43) Pub. Date: Feb. 19, 2009

(54) DIESEL-ELECTRIC DRIVE SYSTEM HAVING A SYNCHRONOUS GENERATOR WITH PERMANENT-MAGNET EXCITATION

(75) Inventors: Andreas Fuchs, Erlangen (DE); Olaf Korner, Nurnberg (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Siemens Aktiengesellschaft, Munchen (DE)

(21) Appl. No.: 12/282,001

(22) PCT Filed: Jan. 17, 2007
(86) PCT No.: PCT/EP07/50446

§ 371 Date: Sep. 8, 2008

(30) Foreign Application Priority Data
Mar. 7, 2006 (DE) 10 2006 010 536.2

(51) Int. Cl. H02P 3/22

(52) U.S. Cl. 318/375

(57) ABSTRACT

The invention relates to a diesel-electric drive system comprising a permanently excited synchronous generator (4), which is mechanically coupled to a diesel motor (2) on the rotor side and has an electrical connection to a voltage link converter (6) on the stator side, said converter having a respective self-commutated pulse-controlled converter (12, 14) on the generator and load sides. The converters are interconnected on the d.c. voltage side by means of a d.c. link (18). The system also comprises a braking resistor (20), which can be electrically connected to said d.c. link (18). According to the invention, each connection (R, S, T) of the pulse-controlled converter (12) in the voltage link converter (6) on the generator side can be electrically connected to a respective braking resistor (34, 36, 38) by means of an actuator (32), said connections being electrically interlinked. This permits the provision of a diesel-electric drive system that no longer requires an additional brake attenuator.

The invention relates to a diesel-electric drive system as claimed in the precharacterizing clause of claim 1.

A drive system of this generic type is disclosed in the publication entitled “Energy Efficient Drive System for a Diesel Electric Shunting Locomotive”, by Olaf Koerner, Jens Brand and Karsten Rechenberg, printed in the “EPE'2005” Conference Proceedings, from the EPE Conference in Dresden on Sep. 11-14, 2005. This publication compares two diesel-electric drive systems having a synchronous generator with permanent-magnet excitation, with one another. These two drive systems differ only in that the generator-side converter of the voltage intermediate-circuit converter is formed on the one hand by a diode rectifier and on the other hand by a self-commutated pulse-controlled converter. In this publication, the self-commutated pulse-controlled converter is referred to as an IGBT rectifier. A braking resistance in both drive systems can be connected to the intermediate circuit of the voltage intermediate-circuit converter. A thyristor which can be turned off is provided for this purpose, and is also referred to as a gate turn-off thyristor (GTO thyristor). By means of this pulse resistance, the DC voltage in the intermediate circuit of the voltage intermediate-circuit converter supplies energy in the braking mode, that is to say the load, in particular a rotating-field machine, into the intermediate circuit, thus ensuring that the maximum permissible intermediate-circuit voltage is not exceeded. A portion of this braking power is used to compensate for the drag of the idling diesel engine. This has the disadvantage that a further converter bridge arm must be used for the brake controller, and the additional rail system of the brake controller must be provided with the intermediate-circuit rail system. In this case, care must be taken to ensure that the brake controller should be connected with low impedance.

Depending on the braking torque, it is possible that it may be necessary to use further converter bridge arms for the brake controller, which are connected electrically in parallel. In addition, a control apparatus is required for the thyristor which can be turned off. Furthermore, the thyristor which can be turned off and is used as a brake controller has a complex circuitry network, which requires a corresponding amount of space.

DE 102 10 164 A1 discloses an apparatus for multiple rectifier feeding of a synchronous motor with permanent-magnet excitation in a power station. This synchronous generator with permanent-magnet excitation has two polyphase stator winding systems with different numbers of turns. One winding system is connected to a controlled rectifier, for example to an IGBT rectifier. The purpose of this controlled rectifier is to regulate the power output and thus the rotation speed of the synchronous generator with permanent-magnet excitation. For this purpose, current flows in the low rotation speed range, and the electrical power therefore flows exclusively via this winding system and thus via the controlled rectifier which is connected to a DC voltage intermediate circuit. The second winding system is connected to an uncontrolled rectifier, for example through a multipulse diode bridge, which is likewise connected to the same DC voltage intermediate circuit as the controlled rectifier. If the line (that is to say phase-to-phase) rotation voltage (also referred to as the rotor voltage) is greater than the intermediate-circuit voltage in the DC voltage intermediate circuit, a current can flow in the second winding system, and is rectified via the uncontrolled rectifier to the DC voltage intermediate circuit. In this case, because of the magnetic coupling between the first and the second winding system, the amplitude and phase angle of the current in the second winding system are influenced by the current in the first winding system, which is regulated by the active rectifier (controlled rectifier). This means that the current in the winding system of the uncontrolled rectifier can also be regulated to a certain extent with the aid of the controlled rectifier. The power transmission of this apparatus is carried mainly by the uncontrolled rectifier, which means that the controlled rectifier is designed for a low power, and therefore costs little. This controlled rectifier, which is in general also referred to as a self-commutated pulse-controlled converter, avoids highly overexcited operation of the synchronous generator with permanent-magnet excitation. Furthermore, this compensates for harmonics in the generator moment, caused by the uncontrolled rectifier.

The invention is now based on the object of improving the diesel-electric drive system of this generic type such that there is no need for an additional brake controller.

According to the invention, this object is achieved by the characterizing features of claim 1 in conjunction with the features of its prechracterizing clause.

Since a braking resistance can be electrically conductively connected by means of a switching apparatus at each generator-side connection of the generator-side self-commutated pulse-controlled converter of the voltage intermediate-circuit converter, this self-commutated pulse-controlled converter additionally carries out the task of braking current regulation. There is therefore no need for a brake controller for the intermediate circuit of the voltage intermediate-circuit converter.

In one advantageous embodiment of this electrical drive system, the voltage intermediate-circuit converter has a further self-commutated pulse-controlled converter on the generator side, which is connected on the DC voltage side to the DC voltage intermediate circuit of the voltage intermediate-circuit converter, with these two generator-side self-commutated pulse-controlled converters each being linked on the AC voltage side to one connection of a first and second inductor, with a second connection of each first inductor being linked by means of the switching apparatus to the braking resistance and by means of a further switching apparatus and a stator-side connection of the synchronous generator with permanent-magnet excitation, and with a second connection of each second inductor being connected to a stator-side connection of the synchronous generator with permanent-magnet excitation. The use of a further generator-side pulse-controlled converter and of first and second inductors in this diesel-electric drive system allows engine braking in the case of the diesel engine, as in the case of a commercial vehicle, in the braking mode, as a result of which a portion of the power in the electrical brake is dissipated via the diesel engine. The size of the braking resistance can be correspondingly reduced, for the same power. In the generator mode, the two polyphase self-commutated pulse-controlled converters which are connected in parallel on the generator side are decoupled on the input side by these first and second inductors.

In a further advantageous embodiment of the diesel-electric drive system, the synchronous generator with permanent-magnet excitation has two separate stator winding systems and the voltage intermediate-circuit converter has two self-commutated pulse-controlled converters on the generator side, whose connections on the AC voltage side are each linked to a stator-side connection of one of the two stator winding systems. In consequence, the stator windings of the two winding systems of the synchronous generator with permanent-magnet excitation are each connected to one generator-side self-commutated pulse-controlled converter of the voltage intermediate-circuit converter, which are jointly connected on the DC voltage side to an intermediate circuit of the voltage intermediate-circuit converter. On the AC voltage side, one of these two generator-side self-commutated pulse-controlled converters of the voltage intermediate-circuit converter is linked by means of a switching apparatus to a braking resistance. This embodiment of the diesel-electric drive system according to the invention also allows engine braking in the case of the diesel engine as in the case of commercial vehicles, so that a portion of the power in electrical brakes can be dissipated via the diesel engine. This allows the braking resistance to be correspondingly reduced in size.

Further advantageous refinements of the diesel-electric drive system are specified in dependent claims 4 to 8.

In order to explain the invention further, reference is made to the drawing, which schematically illustrates a plurality of exemplary embodiments of a diesel-electric drive system according to the invention, and in which:

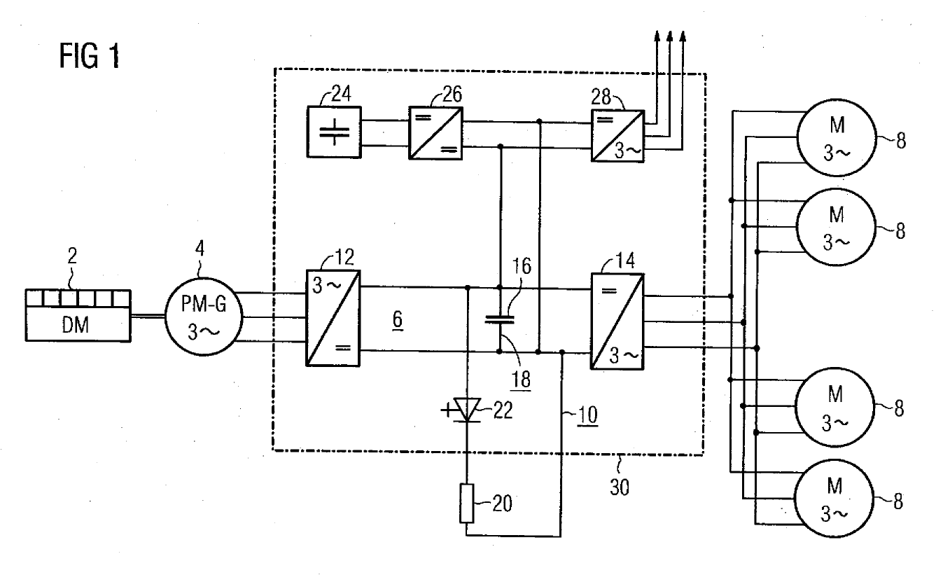

FIG. 1 shows an equivalent circuit of a diesel-electric drive system of this generic type,

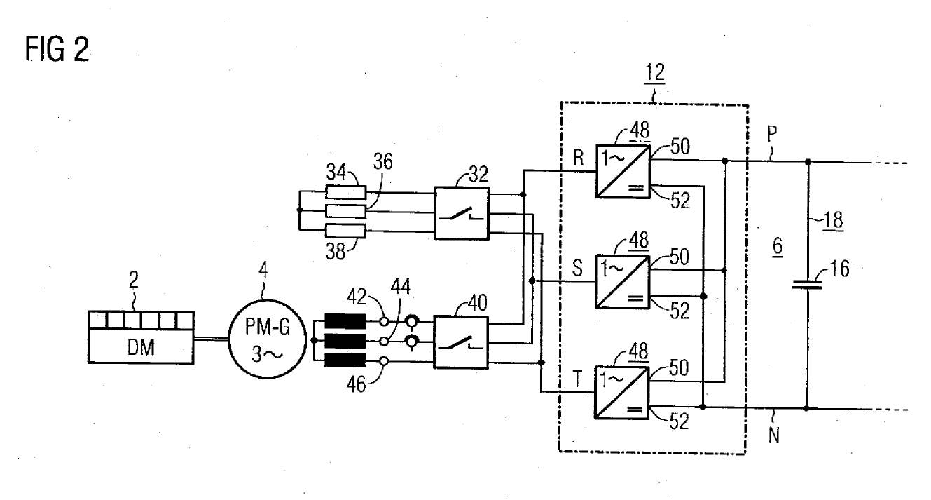

FIG. 2 shows an equivalent circuit of a first embodiment of a diesel-electric drive system according to the invention,

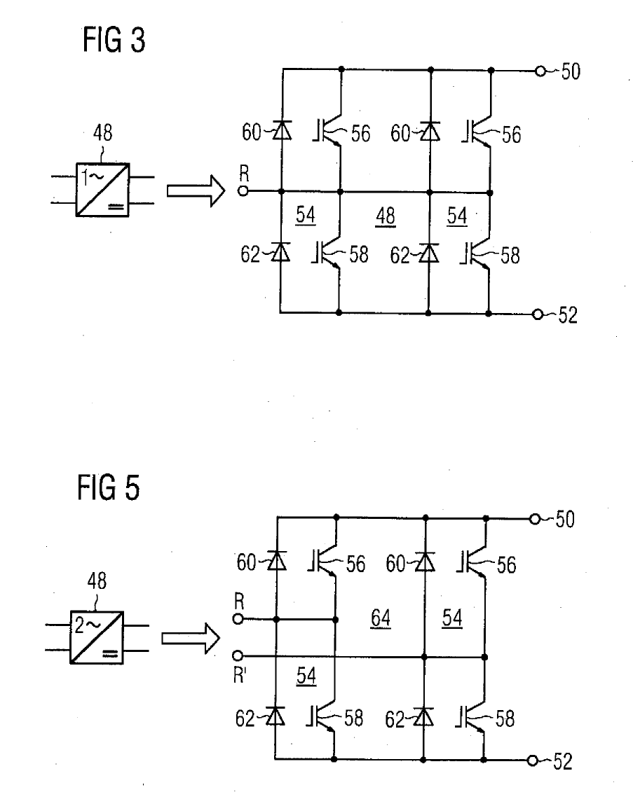

FIG. 3 shows an equivalent circuit of a converter bridge arm module of a generator-side self-commutated pulse-controlled converter of a voltage intermediate-circuit converter as shown in FIG. 2,

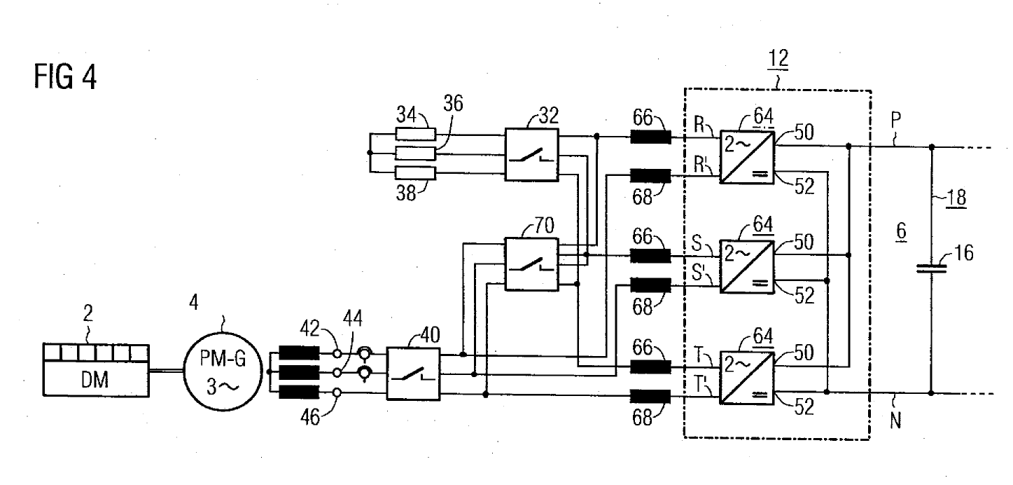

FIG. 4 shows an equivalent circuit of a second embodiment of a diesel-electric drive system according to the invention,

FIG. 5 shows an equivalent circuit of a double-converter bridge arm module of a generator-side self-commutated pulse-controlled converter of a voltage intermediate-circuit converter as shown in FIG. 4, and

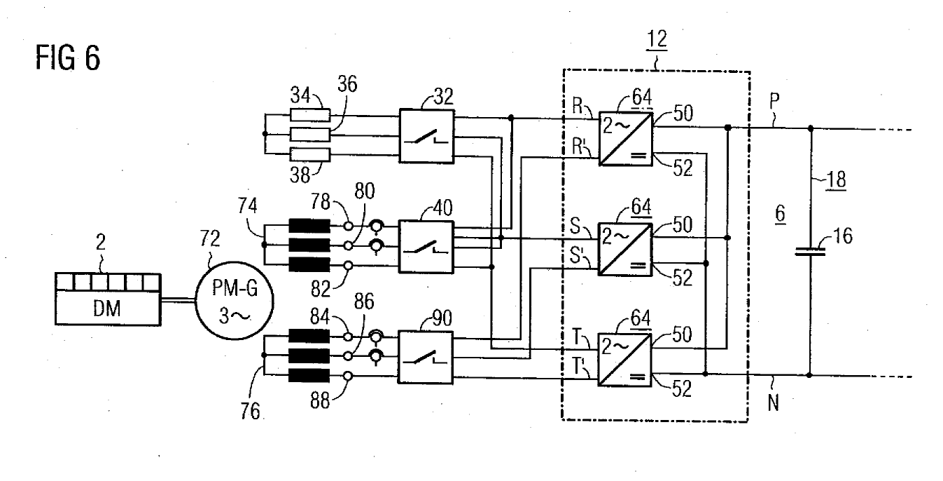

FIG. 6 shows an equivalent circuit of a third embodiment of a diesel-electric drive system according to the invention.

In FIG. 1, which shows an equivalent circuit of a diesel-electric drive system of this generic type, 2 denotes a diesel engine, 4 a synchronous generator with permanent-magnetic excitation, 6 a voltage intermediate-circuit converter, 8 a plurality of rotating-field machines, in particular three-phase asynchronous motors, and 10 denotes a brake chopper. The voltage intermediate-circuit converter has a generator side and load-side self-commutated pulse-controlled converter 12 and 14, respectively, which are electrically conductively connected to one another on the DC voltage side by means of an intermediate circuit 18 which has an intermediate-circuit capacitor bank 16. The brake chopper 10 is connected electrically in parallel with this intermediate circuit 18 and has a braking resistance 20 and a brake controller 22, for example a thyristor which can be turned off, and these items are electrically connected in series. In addition, this equivalent circuit shows a capacitor bank 24, in particular composed of supercaps, a DC/DC converter 26 and an auxiliary inverter 28. On the input side, this DC/DC converter 26 is linked to the capacitor bank 24 and, on the output side, it is linked to the connections on the DC voltage side of the auxiliary inverter 28. In addition, the DC/DC converter 26 is electrically connected on the output side to the intermediate circuit 18 of the voltage-intermediate circuit converter 6. Auxiliary drives are connected to the AC voltage side connections of the auxiliary inverter 28, although these are not illustrated explicitly here. The diesel engine 2 and the synchronous generator 4 with permanent-magnet excitation are mechanically coupled to one another on the rotor side, with this synchronous generator 4 with permanent-magnet excitation being linked on the stator side to connections on the AC voltage side of the generator-side self-commutated pulse-controlled converter 12 of the voltage intermediate-circuit converter 6.

Since this equivalent circuit is an equivalent circuit of a diesel-electric shunting locomotive, 30 denotes a traction container which accommodates the converter electronics. The braking resistance and the diesel-driven synchronous generator 4 with permanent-magnet excitation are arranged outside this traction container 30. The four three-phase asynchronous motors 8 are the motors for the two bogies of a diesel-electric shunting locomotive.

The braking resistance 20, which in this equivalent circuit is in the form of a resistor, may also be formed from series-connected resistances. The thyristor 22 which can be turned off is a converter bridge arm module in this implementation, in which only the associated free-wheeling diode is used instead of a second thyristor which can be turned off. This converter bridge arm module also includes a circuitry network for the thyristor which can be turned off, and a so-called gate unit.

FIG. 2 schematically illustrates an equivalent circuit of a first embodiment of a diesel-electric drive system according to the invention. The load-side self-commutated pulse-controlled converter 14 of the voltage intermediate-circuit converter 6, and the three-phase asynchronous motors 8, as shown in FIG. 1, are not shown in this illustration, for the sake of clarity. The AC voltage-side connections R, S and T of the generator-side self-commutated pulse-controlled converter 12 of the voltage intermediate-circuit converter 6 can each be connected on the one hand by means of a switching apparatus 32 to a braking resistance 34, 36 and 38 and on the other hand by means of a circuit breaker 40 to a stator-side connection 42, 44 and 46 of the synchronous generator 4 with permanent-magnet excitation. This illustration also shows the stator winding system of this synchronous generator 4 with permanent-magnet excitation. In this illustration, the switching apparatuses for each phase of the drive system are symbolized by one switching apparatus 32. This also applies to the circuit breaker 40. Braking resistances 34, 36 and 38 in this illustration are electrically connected in star, and their values correspond to that of the braking resistance 20 in the embodiment shown in FIG. 1. These braking resistances 34, 36 and 38 can also be electrically connected in delta. A three-phase isolator is provided as the switching apparatus 32. An isolator such as this is opened with no current flowing. The circuit breaker 40 is provided for protection of the self-commutated pulse-controlled converter 12. A purely electrical switching apparatus 32 may also be provided instead of an electromechanical switching apparatus 32. Thyristors are used for this purpose and are electrically connected in delta, with the braking resistances 34, 36 and 38 each being electrically conductively connected to two thyristors, which are electrically connected in series.

The generator-side self-commutated pulse-controlled converter 12 of the voltage intermediate-circuit converter 6 is formed by means of converter bridge arm modules 48 in this embodiment of the diesel-electric drive system. An equivalent circuit of these converter bridge arm modules 48 is illustrated in more detail in FIG. 3. The DC-voltage-side connections 50 and 52 of each converter bridge arm module 48 of the generator-side self-commutated pulse-controlled converter 12 are each electrically conductively connected to a potential in the intermediate circuit 18 of the voltage intermediate-circuit converter 6. In this case, the connections 50 on the DC voltage side of the three converter bridge arm modules 48 of the self-commutated pulse-controlled converter 12 are each connected to a positive potential P in the intermediate circuit 18 while, in contrast, the DC-voltage-side connections 52 of these three converter bridge arm modules 48 are each linked to a negative potential N in the intermediate circuit 18.

According to this equivalent circuit in FIG. 3, the converter bridge arm module 48 has two bridge arm modules 54, which are electrically connected in parallel. Each bridge arm module 54 has two semiconductor switches 56 and 58 which can be turned off and are electrically connected in series, in particular two insulated gate bipolar transistors (IGBT), which are each provided with a corresponding free-wheeling diode 60 or 62. In traction technology, traction converters are designed to be as modular as possible, with a bridge arm module 54 being used as the smallest unit. In the illustration shown in FIG. 3, a converter bridge arm module 48 for high power is obtained by connecting two bridge arm modules 54 in parallel.

FIG. 4 shows an equivalent circuit of a second embodiment of the diesel-electric drive system according to the invention. In comparison to the embodiment shown in FIG. 2, this embodiment has a generator-side self-commutated pulse-controlled converter 12 formed from two self-commutated pulse-controlled converters. In this illustration, this self-commutated pulse-controlled converter 12 is formed by its individual double-converter bridge arm modules 64. An equivalent circuit of a double-converter bridge arm module 64 such as this is illustrated in more detail in FIG. 5. In this refinement of the self-commutated pulse-controlled converter 12 as well, the connections 50 on the DC voltage side of the three double-converter bridge arm modules 64 are each electrically conductively connected to the positive potential P in the intermediate circuit 18 of the voltage intermediate-circuit converter 6 while, in contrast, the connections 52 on the DC voltage side of these double-converter bridge arm modules 64 are each connected to the negative potential N in the intermediate circuit 18 of the voltage intermediate-circuit converter 6.

The connections R, S and T, as well as R′, S′ and T′, respectively, on the AC voltage side of the two generator-side self-commutated pulse-controlled converters are respectively linked to an inductor 66 or 68. The inductors 68 are used to link the connections R′, S′ and T′ on the AC voltage side of one self-commutated pulse-controlled converter by means of the circuit breaker 40 to the stator-side connections 42, 44 and 46 of the stator winding system of the synchronous generator 4 with permanent-magnet excitation. The inductors 66 are used to link the connections R, S and T on the AC voltage side of the other self-commutated pulse-controlled converter on the one hand by means of the switching apparatus 32 to the braking resistances 34, 36 and 38 and on the other hand by means of a further switching apparatus 70 to the stator-side connections 42, 44 and 46 of the stator winding system of the synchronous motor 4 with permanent-magnet excitation. The use of two self-commutated pulse-controlled converters, which are linked on the DC voltage side to the same intermediate circuit 18, as generator-side self-commutated pulse-controlled converters 12 of the voltage intermediate-circuit converter 6, and the use of the associated inductors 66, 68 allows engine braking in the case of the diesel engine 2, as in the case of a commercial vehicle. In consequence, a portion of the power in the electrical brake is dissipated via the diesel engine 2. This allows the braking resistances 34, 36 and 38 to be correspondingly reduced in size.

The double-converter bridge arm module 64 shown in FIG. 5 has two bridge arm modules 54 in the same way as the converter bridge arm module 48 shown in FIG. 3, and these are electrically connected in parallel on the DC voltage side. On the AC voltage side, the connections, for example R and R′, are still isolated from one another. Three double-converter bridge arm modules 64 as shown in FIG. 5 therefore form three-phase self-commutated pulse-controlled converters with the connections R, S, T and R′, S′, T′ on the AC voltage side. On the DC voltage side, these two self-commutated pulse-controlled converters feed an intermediate circuit 18 of the voltage intermediate-circuit converter 6.

FIG. 6 schematically illustrates an equivalent circuit of a third embodiment of a diesel-electric drive system according to the invention. This third embodiment differs from the second embodiment of the diesel-electric drive system as shown in FIG. 4 in that a synchronous generator 72 with permanent-magnet excitation and with two winding systems 74 and 76 is provided as the synchronous generator 4 with permanent-magnet excitation. The stator-side connections 78, 80, 82 of the winding system 74 can be connected by means of a circuit breaker 40 to connections R, S and T on the AC voltage side of one self-commutated pulse-controlled converter while, in contrast, the stator-side connections 84, 86 and 88 of the second stator winding system 76 can be connected by means of a further circuit breaker 90 to connections R′, S′ and T′ on the AC voltage side of the other self-commutated pulse-controlled converter of the generator-side self-commutated pulse-controlled converter 12 of the voltage intermediate-circuit converter 6 of the diesel-electric drive system. The connections R, S and T on the AC voltage side of one self-commutated pulse-controlled converter of the generator-side self-commutated pulse-controlled converter 12 of the voltage intermediate-circuit converter 6 can additionally be electrically conductively connected by means of the switching apparatus 32 to the braking resistances 34, 36 and 38. The use of a synchronous generator 72 with permanent-magnet excitation and with two stator winding systems 74 and 76 instead of a synchronous generator 4 with permanent-magnet excitation and with one stator winding system saves the six inductors 66 and 68 and their circuitry, in comparison with the embodiment of the diesel-electric drive system shown in FIG. 4. On the other hand, there is no difference in the operation of these two embodiments. This means that, in the case of this third embodiment as well, engine braking is possible in the case of a diesel engine 2 as in the case of a commercial vehicle. In consequence, a portion of the braking power is dissipated via the diesel engine 2, thus allowing the braking resistances 34, 36 and 38 to be made correspondingly small, without changing the braking performance of the diesel-electric drive system. In consequence, these braking resistances 34, 36 and 38 occupy considerably less installation space.

1-8. (canceled)

9. A diesel-electric drive system, comprising:
a permanent-magnet-excited synchronous generator with a rotor and a stator, wherein the rotor is mechanically coupled to a diesel engine and the stator is electrically connected to a voltage intermediate-circuit converter, said voltage intermediate-circuit converter comprising a self-commutated pulse-controlled converter on the generator side and on the load side, with the generator side and the load side being linked by a DC voltage intermediate circuit;
a plurality of braking resistances having first terminals connected at a common junction point and second terminals; and
a switching apparatus switchably connecting output terminals of the generator-side self-commutated pulse-controlled converter to the second terminals in one-to-one correspondence.

10. The diesel-electric drive system of claim 9, wherein the generator-side self-commutated pulse-controlled converter comprises an additional self-commutated pulse-controlled converter having a DC voltage side which is electrically connected to the DC voltage intermediate circuit, wherein an AC side of the self-commutated pulse-controlled converter and the additional self-commutated pulse-controlled converter of the generator-side are electrically connected to corresponding first terminals of first and second inductors, wherein a second terminal of each first inductor is connected by the switching apparatus to a corresponding one of the braking resistances and by an additional switching apparatus to corresponding stator terminals of the stator, and wherein a second terminal of each second inductor is directly connected to corresponding stator terminals.

11. A diesel-electric drive system of claim 9, comprising two separate stator winding systems, wherein the generator-side self-commutated pulse-controlled converter comprises two self-commutated pulse-controlled converters with DC voltage sides that are electrically connected in common to the DC voltage intermediate circuit, wherein AC terminals of a first of the two self-commutated pulse-controlled converters are connected by the switching apparatus with braking resistances and with stator-side terminals of a first stator winding system in one-to-one correspondence, and wherein AC terminals of a second of the two self-commutated pulse-controlled converters are connected with stator-side terminals of a second stator winding system in one-to-one correspondence.

12. The diesel-electric drive system of claim 9, further comprising a circuit breaker connected in series with stator-side terminals of the stator.

13. The diesel-electric drive system of claim 9, wherein the switching apparatus comprises a circuit breaker.

14. The diesel-electric drive system of claim 9, wherein the switching apparatus comprises a series-connected thyristor.

15. The diesel-electric drive system of claim 9, wherein the braking resistances are electrically connected in a star configuration.

16. The diesel-electric drive system of claim 9, wherein the braking resistances are electrically connected in series.
